(19) United States
(12) Patent Application Publication
(10) Pub. No.: US 2005/0080190 A1
(43) Pub. Date: Apr. 14, 2005

(54) Tyre comprising a cycloolefin polymer tread band and elastomeric composition used therein

(76) Inventors: Maurizio Galimberti, Milano (IT); Michela Caprio, Avellino (AV) (IT); Luigi Fino, Bovisio Masciago (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/497,322

(22) PCT Filed: Dec. 21, 2001
(86) PCT No.: PCT/EP01/15269

(51) Int. Cl. C08F 8/00

(52) U.S. Cl. 525/191

(57) ABSTRACT

Tyre for vehicle wheels, comprising at least one component made of a crosslinked elastomeric material, in which said component includes an elastomeric composition comprising: (a) at least one diene elastomeric polymer, (b) at least one cycloolefin polymer, said cycloolefin polymer having a glass transition temperature (T_{g}) of not less 50° C. Preferably, said component including said composition is a tyre tread band.

The present invention relates to a tyre for vehicle wheels, to a tread band and to a crosslinkable elastomeric composition.

More particularly, the present invention relates to a tyre for vehicle wheels comprising at least one component made of crosslinked elastomeric material including at least one cycloolefin polymer.

The present invention moreover relates to a tread band including a crosslinkable elastomeric composition comprising at least one cycloolefin polymer, and also to an elastomeric composition comprising at least one cycloolefin polymer.

As is known, in the field of producing tyres for vehicles wheeels, in particular very-high-performance tyres such as, for example, tyres designed for high-powered cars or, more generally, tyres intended for applications involving high operating speeds, one of the main problems to solve is always that of obtaining a good roadholding when the tyre exceeds the normal working temperatures of the tyre (40° C.-70° C.) following high thermomechanical stresses such as, for example, those derived from driving the vehicle under “hard handling” conditions.

Said tyres, which are commonly referred to as “HP” and “UHP” (“High Performance” and “Ultra High Performance”) tyres, are in particular those belonging to the classes “V” and “Z” that respectively provide for maximum speeds over 210 Km/h and 240 Km/h, for which the operating performance at high temperatures is undoubtedly one of the most important factor.

Attempts have been made in the prior art to improve the performance of tyres over a wider range of temperatures than the normal working temperatures.

For example, European patent application EP 117,834 describes a tyre with a tread band consisting of a sulphur-crosslinked elastomeric composition which includes a dispersion comprising from about 2 phr to about 15 phr, preferably from about 3 phr to about 10 phr, of a polystyrene resin in the form of particles with a softening point of between about 90° C. and about 120° C., preferably between about 90° C. and about 110° C. The presence of said polystyrene resin in the tread band of the tyre is said to increase the holding on wet surfaces while keeping the rolling resistance unchanged under the normal conditions of use, and to ensure holding under conditions of particularly high friction. In this respect, the following explanation is given. When the temperature of the tread band reaches 120° C.-150° C. or higher values, due to particularly high friction conditions, and thus temperature values above the softening point of the polystyrene resin, the outer part of the tread band softens and this is believed to allow an increase in traction and better roadholding of the tyre. On the other hand, during normal use of the tyre, up to temperatures of about 70° C., and thus temperature values below the softening point of the polystyrene resin, said resin remains passive and the tyre maintains low rolling resistance values.

European patent application EP 1,029,874 describes a polymer resin derived from the polymerization of limonene, dicyclopentadiene and t-butylstyrene, for use in elastomeric compositions for manufacturing tyre tread bands. The presence of said polymer resin in the tyre tread band is said to make it possible to obtain an increase in holding on dry surfaces without having an adverse effect on the durability of the tyre.

European patent application EP 1,063,246 describes a polymer resin derived from the polymerization of limonene, dimethyldicyclopentadiene, indene and vinyltoluene, for use in elastomeric compositions for manufacturing tyre tread bands. The presence of said polymer resin in the tyre tread band is said to make it possible to obtain an increase in the holding on dry surfaces without having an adverse effect on the durability of the tyre.

European patent application EP 1,050,547 describes a polymer resin derived from the polymerization of limonene and dimethyldicyclopentadiene for use in elastomeric compositions for manufacturing tyre tread bands. The presence of said polymer resin in the tyre tread band is said to make it possible to obtain an increase in the holding on dry surfaces without having an adverse effect on the durability of the tyre.

European patent application EP 754,070 describes a crosslinkable elastomeric composition comprising a polymer base containing a crosslinkable unsaturated chain and at least one organic compound which is solid at ambient temperature, said compound being substantially insoluble in the polymer base and having a first-order or second-order transition temperature of between 80° C. and 160° C. and an average molecular weight of between 10,000 and 1,000,000. Said organic compound is selected from polyphenylenether (such as, for example, Vestoran® 1100 from Hüls), polyethylene, polypropylene, polymethyl methacrylate, polyvinyl alcohol, ethylene/vinyl alcohol copolymers, acrylonitrile/butadiene/styrene (ABS) terpolymers, ethylene/methacrylic acid copolymers, styrene/isoprene (SIS), styrene/butadiene (SBS), styrene/ethylene-butylene/styrene (S-E/B-S) and styrene/ethylene-propylene (S/E-P) block copolymers, or mixtures thereof. The abovementioned elastomeric composition may be used to prepare tread bands and is said to make it possible to obtain tyres with both low rolling resistance at the normal temperatures of use (40° C.-70° C.) and high roadholding when the tyre exceeds said temperatures due to high thermomechanical stresses.

U.S. Pat. No. 4,487,892 describes a rubber composition for use in tyres which comprises 1%-30% by weight of a non-crystallizable resinous polymer having a glass transition temperature (T_{g}) of not less than 110° C. and 70%-99% by weight of at least one rubber selected from styrene/butadiene copolymer rubber containing not more than 60% by weight of bound styrene, natural rubber, polybutadiene rubber having 1,4-configuration of not less than 80%, polybutadiene rubber having 1,2-configuration of not less than 50%, butyl rubber, halogenated butyl rubber and polyisoprene rubber having cis-1,4-configuration of not less than 90%. Said non-crystallizable resinous polymer is selected from: α-methylstyrene homopolymer, α-methylstyrene/styrene copolymer, nuclear-substituted styrene homopolymer, nuclear-substituted α-methylstyrene homopolymer, styrene-nuclear-substituted styrene copolymer, styrene-nuclear-substituted α-methylstyrene copolymer, and copolymers thereof containing a diene monomer. The abovementioned rubber composition may be used to prepare tread bands and is said to make it possible to obtain tyres having high driving performances, i.e. considerably improved controllability and stability during high-speed running.

U.S. Pat. No. 4,427,831 describes a rubber material comprising a mixture of an ordinary rubber and a powder of norbornene polymer which hardens at service temperature on ice and softens at higher temperatures and which does not lose its shape as a powder when heated during curing or shaping. Said ordinary rubber is selected from: butadiene rubber, styrene-butadiene rubber, isoprene rubber, or a natural rubber. The abovementioned rubber material may be formed into rubber articles such as tyres and shoes soles which have an excellent grip on ice.

U.S. Pat. No. 4,166,083 describes a rubber composition comprising (a) 70% to 90% by weight of at least one diene rubber, and (b) 30% to 5% by weight of a polymer or copolymer obtained by polymerizing at least one norbornene compound. The abovementioned rubber composition, which may be used in tyres manufacturing, is said to have high green strength and improved tensile modulus, abrasion resistance and wet skid resistance.

Japanese Patent application 2001/114837 describes a crosslinkable elastomeric composition comprising (A) a non-conjugated cyclopolyene including 93 mol %-70 mol % of an α-olefin and 7 mol %-30 mol % of a cyclopolyene, said cyclopolyene having an intrinsic viscosity (η) of 0.01 dl/g to 20 dl/g measured in decaline at 135° C., a glass transition temperature (T_{g}) not higher than 40° C. and a iodine value of 50 to 150; and (B) a diene rubber. The abovementioned elastomeric composition may be used to prepare tread bands and is said to make it possible to obtain tyres having excellent breaking properties and excellent fuel cost performance.

The Applicant has now found that it is possible to obtain crosslinkable elastomeric compositions capable of being used advantageously in the production of crosslinked manufactured products, in particular in the production of very-high-performance tyres, by using a cycloolefin polymer having a glass transition temperature (T_{g}) of not less than 50° C. In this way, it is possible to obtain a crosslinkable elastomeric composition which give a high roadholding when the tyre exceeds the normal working temperatures due to high thermomechanical stresses. Besides, the cycloolefin polymer is able to exert a reinforcing action on the elastomeric material, thus replacing, at least partially, if necessary, the conventional reinforcing fillers, while keeping good, both tensile and dynamic, mechanical properties and without impairing abrasion resistance.

According to a first aspect, the present invention thus relates to a tyre for vehicle wheels, comprising at least one component made of a crosslinked elastomeric material, in which said component includes an elastomeric composition comprising:
(a) at least one diene elastomeric polymer;
(b) at least one cycloolefin polymer, said cycloolefin polymer having a glass transition temperature (T_{g}) of not less than 50° C., preferably in the range of from 60° C. to 250° C., more preferably from 80° C. to 200° C., even more preferably from 100° C. to 160° C.

According to one preferred embodiment, the present invention relates to a tyre for vehicle wheels, comprising:
a carcass structure with at least one carcass ply shaped in a substantially toroidal configuration, the opposite lateral edges of which are associated with respective right-hand and left-hand bead wires, each bead wire being enclosed in a respective bead;
a belt structure comprising at least one belt strip applied in a circumferentially external position relative to said carcass structure;
a tread band superimposed circumferentially on said belt structure;
a pair of side walls applied laterally on opposite sides relative to said carcass structure;
   in which said component which includes said elastomeric composition is the tread band.

According to a further aspect, the present invention relates to a tyre tread band including a crosslinkable elastomeric composition comprising:
(a) at least one diene elastomeric polymer;
(b) at least one cycloolefin polymer, said polymer having a glass transition temperature (T_{g}) of not less than 50° C., preferably in the range of from 60° C. to 250° C., more preferably from 80° C. to 200° C., even more preferably from 100° C. to 160° C.

According to a further aspect, the present invention relates to an elastomeric composition comprising:
(a) at least one diene elastomeric polymer;
(b) at least one cycloolefin polymer, said polymer having a glass transition temperature (T_{g}) of not less than 50° C., preferably in the range of from 60° C. to 250° C., more preferably from 800C to 200° C., even more preferably from 100° C. to 160° C.

According to a further aspect, the present invention relates to a crosslinked elastomeric manufactured product obtained by crosslinking the aboivementioned elastomeric composition

According to one preferred embodiment, said cycloolefin polymer (b) is present in the elastomeric composition in an amount of from 0.1 phr to 100 phr, preferably from 3 phr to 60 phr, even more preferably from 5 phr to 40 phr.

For the purposes of the present description and of the claims, the term “phr” means the parts by weight of a given component of the elastomeric composition per 100 parts by weight of the elastomeric polymer.

According to one preferred embodiment, the diene elastomeric polymer (a) which may be used in the present invention may be selected from those commonly used in sulphur-crosslinkable elastomeric compositions, that are particularly suitable for producing tyres, that is to say from elastomeric polymers or copolymers with an unsaturated chain having a glass transition temperature (T_{g}) generally below 20° C., preferably in the range of from 0° C. to −90° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be chosen, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene and isoprene are particularly preferred.

Monovinylarenes which may optionally be used as comonomers generally contain from 8 to 20, preferably from 8 to 12 carbon atoms, and may be chosen, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be chosen, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene elastomeric polymer (a) which may be used in the present invention may be chosen, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The elastomeric composition according to the present invention may optionally comprise at least one elastomeric polymer of one or more monoolefins with an olefinic comonomer or derivatives thereof (c). The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

A diene elastomeric polymer (a) or an elastomeric polymer (c) functionalized by reaction with suitable terminating agents or coupling agents may also be used. In particular, the diene elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European patent EP 451 604, or patents U.S. Pat. No. 4,742,124 and U.S. Pat. No. 4,550,142).

According to one preferred embodiment, the cycloolefin polymer (b) which may be used in the present invention may be selected from:
(b-1) a cycloolefin random copolymer obtained by copolymerizing (i) at least one aliphatic α-olefin and (ii) at least one cycloolefin represented by the following formula (I) and, optionally, (iii) a polyene;
(b-2) a ring-opening polymer of at least one cycloolefin represented by the following formula (I); and
(b-3) a hydrogenation product of a ring-opening polymer of at least one cyclolefin represented by the following formula (I): 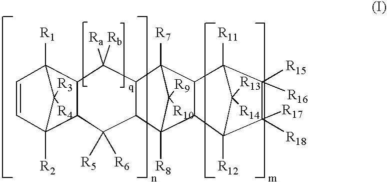
   wherein:
n is 0 or a positive integer, preferably is 0 or 1;
m is 0 or a positive integer;
q is 0 or 1;
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, Rₐ ed R_{b}, which may be equal or different from each other, represent a hydrogen atom, a halogen atom, or an aliphatic, an alicyclic or an aromatic hydrocarbon group;
R₁₅, R₁₆, R₁₇, R₁₈, may be linked each other to form a monocyclic or polycyclic group which may have double bonds; and
R₁₅ and R₁₆, or R₁₇ and R₁₈, may together form an alkylidene group.

The term “aliphatic α-olefin” generally means an olefin of formula CH₂═CH—R, in which R represents a hydrogen atom, a linear or branched alkyl group containing from 1 to 12 carbon atoms. Preferably, the aliphatic α-olefin is selected from: ethylene, propylene, 1-butene, isobutylene, 1-pentene, 1-hexene, 3-methyl-1-butene, 3-methyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, or mixture thereof. Of these, preferred is ethylene or propylene, particularly preferred is ethylene.

Examples of the halogen atom include fluorine atom, chlorine atom, bromine atom and iodine atom.

Examples of the hydrocarbon group generally include alkyl group having from 1 to 20 carbon atoms, cycloalkyl group having from 3 to 15 carbon atoms, and aromatic hydrocarbon group having from 6 to 14 carbon atoms.

Specific examples of the alkyl group include methyl, propyl, isopropyl, amyl, octyl, decyl, dodecyl, octadecyl, these alkyl groups may be substituted with halogen atoms.

A specific example of the cycloalkyl group is cyclohexyl.

Specific examples of the aromatic hydrocarbon group include phenyl, naphthyl.

Moreover, in the above formula (I), R₁₅ and R₁₆, R₁₇ and R₁₈, R₁₅ and R₁₇, R₁₆ and R₁₈, R₁₅ and R₁₈, or R₁₆ and R₁₇, may be linked together to form a monocyclic or polyciclic group, optionally containing a double bonds.

Examples of the monocyclic or polyciclic group are the following: 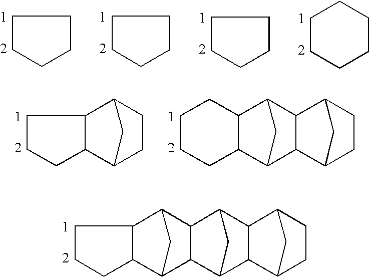
wherein carbon atoms attached with numerals 1 and 2 are those to which substituent R₁₅ or R₁₆ and R₁₇ or R₁₈ are linked respectively.

In the above formula (I), R₁₅ and R₁₆ or R₁₇ and R₁₈ may together form an alkylidene group. This alkylidene group generally has from 2 to 20 carbon atoms and, examples of such alkylidene group include ethylidene, propylidene, isopropylidene.

In the above formula (I), when q is 1, the corresponding ring is a 6-membered ring and, when q is 0, the corresponding ring is a 5-membered ring.

Preferably, the cycloolefin polymer (b) which may be used in the present invention may be selected from copolymers of a cyclic olefin having a norbornene-based structure (preferably norbornene, tetracyclododecene or cyclic olefins having a structure derived from them), and an aliphatic α-olefin (preferably ethylene or propylene) . Among them, norbornene-ethylene copolymer, norbornene-propylene copolymer, tetracyclododecene-ethylene copolymer, tetracyclododecene-propylene copolymer, are particularly preferred. More partycularly, norbornene-ethylene copolymer is preferred.

With reference to a cycloolefin random copolymer (b-1), the term “polyene” generally means a conjugated or non-conjugated diene, triene or tetraene. When a diene comonomer is present, this comonomer generally contains from 4 to 20 carbon atoms and is preferably selected from: linear conjugated or non-conjugated diolefins such as, for example, 1,3-butadiene, 1,4-hexadiene, 1,6-octadiene; monocyclic or polycyclic dienes such as, for example, 1,4-cyclohexadiene, 5-ethylidene-2-norbornene, 5-methylene-2-norbornene, vinylnorbornene, or mixtures thereof. When a triene or tetraene comonomer is present, this comonomer generally contains from 9 to 30 carbon atoms and is preferably selected from trienes or tetraenes containing a vinyl group in the molecule or a 5-norbornen-2-yl group in the molecule. Specific examples of triene or tetraene comonomers which may be used in the present invention are: 6,10-dimethyl-1,5,9-undecatriene, .5,9-dimethyl-1,4,8-decatriene, 6,9-dimethyl-1,5,8-decatriene, 6,8,9-trimethyl-1,6,8-decatriene, 6,10,14-trimethyl-1,5,9,13-pentadecatetraene, or mixture thereof. Preferably, the polyene is a diene.

Usually, the cyclolefin polymer (b) as described above, has an intrinsic viscosity [η] as measured in decalin at 135° C., of from 0.01 dl/g to 10 dl/g, preferably from 0.05 dl/g to 5 dl/g, more preferably 0.3 dl/g to 2 dl/g.

The cycloolefin random copolymer (b-1) generally has the following composition: 40 mol %-85 mol %, preferably 42 mol %-80 mol %, of an aliphatic α-olefin; 15 mol %-60 mol %, preferably 20 mol %-58 mol % of a cycloolefin having formula (I); 0 mol %-10 mol %, preferably 0 mol %-2 mol %, of a polyene.

The cycloolefin random copolymer (b-1) may be obtained by copolymerization of (i) at least one α-olefin with at least (ii) a cycloolefin having formula (I) and, if necessary, (iii) a polyene, in the presence of a catalyst formed from a soluble vanadium compound such as, for example, VOCl₃, VO(C₂H₅)Cl₂, VOCl₂, VOBr₂, and an organoaluminium compound such as, for example, an alkyl- or alkenyl-aluminum compound.

Said copolymerization may be carried out also in the presence of a metallocene compound as catalyst such as, for example, coordination complexes between a transition metal, usually from group IV, in particular titanium, zirconium or hafnium, and two optionally substituted cyclopentadienyl ligands, which are used in combination with a co-catalyst, for example an aluminoxane, preferably methylaluminoxane, and, if necessary of an organoaluminum compound such as, for example, an alkyl- or alkenyl-aluminum compound. In this case, the cycloolefin random copolymer(b-1) has a molecular weight distribution (MWD) index of less than 5, preferably between 1.5 and 3.5.

Said molecular weight distribution index is defined as the ratio between the weight-average molecular weight (M_{w}) and the number-average molecular weight (Mₙ) and may be determined, according to conventional techniques, by gel permeation chromatography.

The ring-opening polymer (b-2) may be obtained by ring-opening polymerization of at least one cycloolefin having formula (I) in the presence of a ring-opening polymerization catalyst. Said ring-opening polymerization catalysts may be selected from:
catalysts formed from at least one halide, one nitrate, or one acetylacetone compound of metal such as ruthenium, rhodium, osmium, indium platinum, molybdenum or tungsten, and at least one reducing agent such as alcohol or tin compound;
catalysts formed from at least one halide or one acetylacetone compound of metal such as titanium, vanadium, zirconium, tungsten or molibdenum, and at least one metallic aluminum compounds.

The hydrogenation product of a ring-opening polymer of a cyclolefin (b-3) may be obtained by hydrogenating the cycloolefin ring-opening polymer (b-2) as prepared above. For hydrogenating the ring-opening polymer (b-2), a conventional hydrogenation process which is carried out in the presence of a hydrogenation catalyst can be adopted.

More details relating to the synthesis of the random cycloolefin copolymers (b-1), (b-2) e (b-3) may be found, for example, in U.S. Pat. Nos. 5,494,969, 5,741,869 and 5,569,711.

Examples of cycloolefin random copolymers (b-1) which may be used in the present invention and which are currently commercially available are the products Topas® from Ticona.

At least one reinforcing filler may advantageously be added to the elastomeric composition according to the present invention, in an amount generally of from 0.1 phr to 120 phr, preferably from 20 phr to 90 phr. The reinforcing filler may be selected from those commonly used for crosslinked manufactured products, in particular for tyres, such as, for example, carbon black, silica, alumina, aluminosilicates, calcium carbonate, kaolin, or mixtures thereof.

The types of carbon black which may be used according to the present invention may be selected from those conventionally used in the production of tyres, generally having a surface area of not less than 20 m²/g (determined by CTAB absorption as described in ISO standard 6810).

The silica which may be used according to the present invention may generally be a pyrogenic silica or, preferably, a precipitated silica, with a BET surface area (measured according to ISO standard 5794/1) of from 50 m²/g to 500 m²/g, preferably from 70 m²/g to 200 m²/g.

When a reinforcing filler comprising silica is present, the elastomeric composition may advantageously incorporate a coupling agent capable of interacting with the silica and of linking it to the elastomeric base during the vulcanization.

Coupling agents that are preferably used are those based on silane which may be identified, for example, by the following structural formula (II):
(R)₃Si—CₙH₂ₙ—X (II)
in which the groups R, which may be identical or different, are selected from: alkyl, alkoxy or aryloxy groups or from halogen atoms, on condition that at least one of the groups R is an alkoxy or aryloxy group; n is an integer between 1 and 6 inclusive; X is a group selected from: nitroso, mercapto, amino, epoxide, vinyl, imide, chloro, —(S)ₘCₙH₂ₙ—Si—(R)₃ in which m and n are integers between 1 and 6 inclusive and the groups R are defined as above.

Among the coupling agents that are particularly preferred are bis(3-triethoxysilylpropyl) tetrasulphide and bis(3-triethoxysilylpropyl) disulphide. Said coupling agents may be used as such or as a suitable mixture with an inert filler (for example carbon black) so as to facilitate their incorporation into the elastomeric composition.

The elastomeric composition according to the present invention may be vulcanized according to known techniques, in particular with sulphur-based vulcanizing systems commonly used for diene elastomeric polymers. To this end, in the composition, after a first stage of thermomechanical processing, a sulphur-based vulcanizing agent is incorporated together with vulcanization accelerators. In this second processing stage, the temperature is generally kept below 120° C. and preferably below 100° C., so as to avoid any unwanted pre-cross-linking phenomena.

The vulcanizing agent most advantageously used is sulphur, or molecules containing sulphur (sulphur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected from: dithiocarbamates, guanidine, thiourea, thiazoles, sulphenamides, thiurams, amines, xanthates, or mixtures thereof.

The elastomeric composition according to the present invention may comprise other commonly used additives chosen on the basis of the specific application for which the composition is intended. For example, the following may be added to said composition: antioxidants, anti-ageing agents, plasticizers, adhesives, anti-ozone agents, modifying resins, fibres (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to the elastomeric composition according to the present invention. The amount of plasticizer generally ranges from 2 phr to 100 phr, preferably from 5 phr to 50 phr.

The elastomeric composition according to the present invention may be prepared by mixing together the polymeric components with the reinforcing filler optionally present and with the other additives according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss) or of co-rotating or counter-rotating twin-screw type.

The cycloolefin polymer (b) may be used in the form of powder, granules or pellets. In order to improve mixing with the other components, such polymers may be used combined with a plasticizer, such as glycerin, pentaerythrite, and the like. Preferably, the compositions according to the present invention are produced in two steps. In a first step, the mixture of the cycloolefin polymer (b) with a portion of the elastomeric polymer is prepared, thereby forming a masterbatch. In a subsequent step, the masterbatch is mixed with the remaining portion of the elastomeric polymer and the other components, according to conventional methods. The first step of masterbatch preparation is preferably carried out in a continuous mixer, for instance a twin-screw extruder, at a temperature of more than 120° C., so as to obtain a good dispersion of the thermoplastic polymer in the elastomeric polymer. The continuous mixers of preferred use are those having an adjustable geometry of the screw and thermal profile of the cylinder.

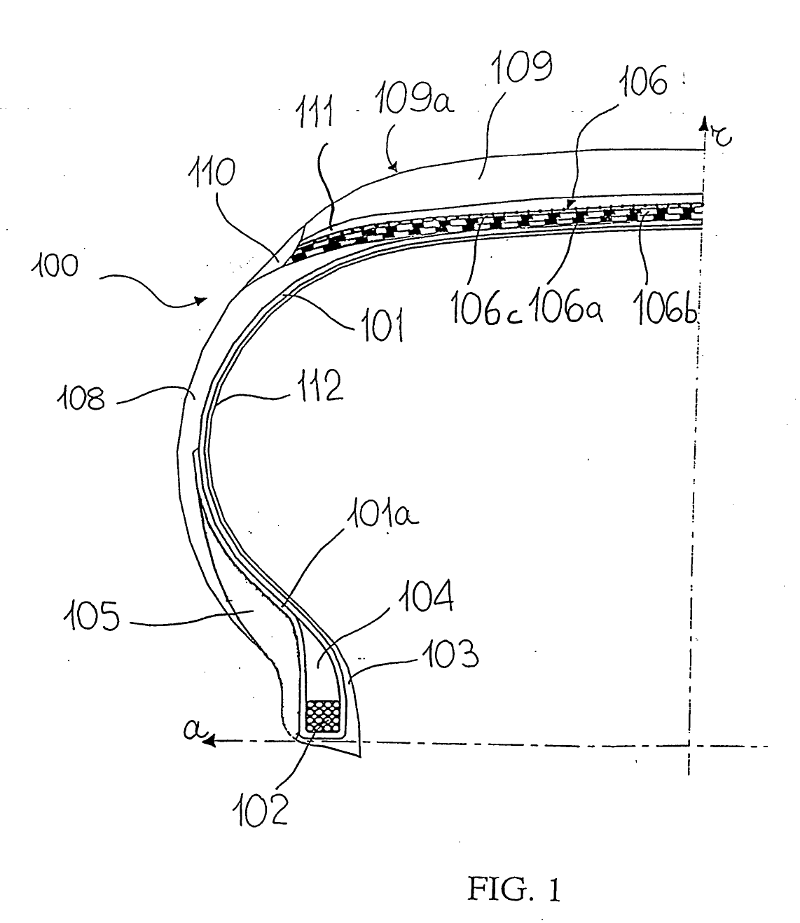

The present invention will now be illustrated in further detail by means of a number of illustrative embodiments, with reference to the attached FIG. 1, which is a view in cross section of a portion of a tyre made according to the invention.

“a” indicates an axial direction and “r” indicates a radial direction. For simplicity, FIG. 1 shows only a portion of the tyre, the remaining portion not represented being identical and symmetrically arranged with respect to the radial direction “r”.

The tyre (100) comprises at least one carcass ply (101), the opposite lateral edges of which are associated with respective bead wires (102). The association between the carcass ply (101) and the bead wires (102) is achieved here by folding back the opposite lateral edges of the carcass ply (101) around the bead wires (102) so as to form the so-called carcass back-folds (101a) as shown in FIG. 1.

Alternatively, the conventional bead wires (102) can be replaced with a pair of circumferentially inextensible annular inserts formed from elongate components arranged in concentric coils (not represented in FIG. 1) (see, for example, European patent applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of elastomeric compound. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. Each bead wire (102) is enclosed in a bead (103), defined along an inner circumferential edge of the tyre (100), with which the tyre engages on a rim (not represented in FIG. 1) forming part of a vehicle wheel. The space defined by each carcass back-fold (101a) contains a bead filler (104) in which the bead wires (102) are embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the carcass ply (101), this side wall extending, in an axially external position, from the bead (103) to the end of the belt structure (106). A tread band (109), whose lateral edges are connected to the side walls (108), is applied circumferentially in a position radially external to the belt structure (106). Externally, the tread band (109), which can be produced according to the present invention, has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109). A underlayer which forms, with the tread band (109), a structure commonly known as a “cap and base” (not represented in FIG. 1) may optionally be placed between the belt structure (106) and the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tyres, a rubber layer (112) generally known as a “liner”, which provides the necessary impermeability to the inflation air of the tyre, may also be provided in a radially internal position relative to the carcass ply (101).

The process for producing the tyre according to the present invention can be carried out according to techniques and using apparatus that are known in the art, as described, for example, in patents EP 199 064, U.S. Pat. No. 4,87.2,822, U.S. Pat. No. 4,768,937, said process including at least one stage of manufacturing the green tyre and at least one stage of vulcanizing this tyre.

More particularly, the process for producing the tyre comprises the stages of preparing, beforehand and separately from each other, a series of semi-finished products corresponding to the various parts of the tyre (carcass plies, belt structure, bead wires, fillers, side walls and tread band) which are then combined together using a suitable manufacturing machine. Next, the subsequent vulcanization stage welds the abovementioned semi-finished products together to give a monolithic block, i.e. the finished tyre.

Naturally, the stage of preparing the abovementioned semi-finished products will be preceded by a stage of preparing and moulding the various blends, of which said semi-finished products are made, according to conventional techniques.

The green tyre thus obtained is then passed to the subsequent stages of moulding and vulcanization. To this end, a vulcanization mould is used which is designed to receive the tyre being processed inside a moulding cavity having walls which are countermoulded to define the outer surface of the tyre when the vulcanization is complete.

Alternative processes for producing a tyre or parts of a tyre without using semi-finished products are disclosed, for example, in the abovementioned patent applications EP 928,680 and EP 928,702.

The green tyre can be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding can be carried out without an inflatable vulcanization chamber, by providing inside the tyre a toroidal metal support shaped according to the configuration of the inner surface of the tyre to be obtained as decribed, for example, in patent EP 242,840. The difference in coefficient of thermal expansion between the toroidal metal support and the crude elastomeric material is exploited to achieve an adequate moulding pressure.

At this point, the stage of vulcanizing the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material can vary in general between 3 min and 90 min and depends mainly on the dimensions of the tyre. When the vulcanization is complete, the tyre is removed from the vulcanization mould.

Although the present invention has been illustrated specifically in relation to a tyre, other crosslinked elastomeric manufactured products that can be produced according to the invention may be, for example, conveyor belts, driving belts or flexible tubes.

The present invention will be further illustrated below by means of a number of preparation examples, which are given for purely indicative purposes and without any limitation of this invention.

### EXAMPLE 1

Preparation of the Masterbatch

A masterbatch comprising the following ingredients was prepared:
75% by weight of SBR: styrene/butadiene copolymer, obtained by emulsion polymerization, containing 40% by weight of styrene, mixed with 37.5% of oil (Europrene® 1721 - EniChem Elastomeri);
25% by weight of Topas® 6013: copolymer of norbornene and ethylene with norbornene content of 45% mol; T_{g}=130° C.; MWD=2; (commercialized by Ticona).

A mixture of the ingredients above reported was fed to a parallel twin-screw (co-rotating) extruder having a length/diameter ratio L/D=30. The maximum temperature reached during the extrusion was of 200° C.±5° C. The masterbatch was cooled by water.

### EXAMPLE 2-5

Preparation of the Elastomeric Compositions

The elastomeric compositions given in Table 1 were prepared as follows (the amounts of the various components are given in phr).

All the ingredients, except for the sulphur and the accelerator, were mixed together in an internal mixer (model Pomini PL 1.6) for about 5 min (1st Stage) . As soon as the temperature reached 145±5° C., the elastomeric composition was discharged. The sulphur, the accelerator and the retardant were then added and mixing was carried out in an open roll mixer (2nd Stage).

TABLE 1

EXAMPLE

| | | | |
|---|---|---|---|
| 2 (*) | 3 (*) | 4 (*) | 5 |

1st Stage

| | | | | |
|---|---|---|---|---|
| SBR | 100 | 100 | 100 | 70 |
| Carbon black | 60 | 60 | 60 | 60 |
| Zinc oxide | 2.5 | 2.5 | 2.5 | 2.5 |
| Stearic acid | 1 | 1 | 1 | 1 |
| Aromatic oil | 10 | — | — | — |
| Methylstyrene | — | 10 | — | — |
| resin | | | | |
| Norsorex ® N | — | — | 10 | — |
| MB Topas ® | — | — | — | 40 |
| 6013 | | | | |
| Antioxidant | 2 | 2 | 2 | 2 |

2^{nd} Stage

| | | | | |
|---|---|---|---|---|
| CBS | 2 | 2 | 2 | 2 |
| Sulphur | 1 | 1 | 1 | 1 |

(*): comparative.
SBR: styrene/butadiene copolymer, obtained by emulsion polymerization, containing 40% by weight of styrene, mixed with 37.5% of oil (Europrene ® 1721 - EniChem Elastomeri);
Carbon black: N115 (Vulcan ® 9 - Cabot);
Methylstyrene resin: α-methylstyrene resin (Kristalex ® F85 - Hercules);
Norsorex ® N: polynorbornene (Zeon Italia S.r.l.);
MB Topas ® 6013: masterbatch of Example 1;
Antioxidant: phenyl-p-phenylenediamine;
CBS (accelerator): N-cyclohexyl-2-benzothiazyl-sulphenamide (Vulkacit ® CZ - Bayer).

The static mechanical properties were measured on samples of the abovementioned elastomeric compositions vulcanized at 151° C. for 30 min, according to ISO standard 37, and hardness in IRHD degrees was measured at 23° C. and at 100° C. (according to ISO standard 48). The results obtained are given in Table 2.

Table 2 also shows the dynamic mechanical properties, measured using an Instron dynamic device in the traction-compression mode according to the following methods. A test piece of the cross-linked material having a cylindrical form (length=25 mm; diameter=14 mm), compression-preloaded up to a 10% longitudinal deformation with respect to the initial length, and kept at the prefixed temperature (70° C. or 10° C.) for the whole duration of the test, was submitted to a dynamic sinusoidal strain having an amplitude of ±3.33% with respect to the length under pre-load, with a 10 Hz frequency. The dynamic mechanical properties are expressed in terms of dynamic elastic modulus (E′) and tandelta (loss factor) values. As is known, the tandelta value is calculated as a ratio between the viscous modulus (E″) and the elastic modulus (E′), both of them being determined with the above dynamic measurements.

Lastly the DIN abrasion values were measured according to ISO standard 4649, also reported in Table 2, expressed as relative volumetric loss with respect to the reference composition of Example 2 (set at 100).

TABLE 2

| EXAMPLE | | | |
|---|---|---|---|
| 2 (*) | 3 (*) | 4 (*) | 5 |

STATIC MECHANICAL PROPERTIES

| | | | | |
|---|---|---|---|---|
| 100% modulus (MPa) | 2.00 | 2.33 | 3.85 | 5.65 |
| 300% modulus (MPa) | 9.39 | 10.25 | 15.20 | — |
| Stress at break | 16.81 | 17.46 | 17.10 | 15.31 |
| (MPa) | | | | |

DINAMIC MECHANICAL PROPERTIES

| | | | | |
|---|---|---|---|---|
| E′ (23° C.) | 8.89 | 10.10 | 12.85 | 20.83 |
| E′ (70° C.) | 4.85 | 5.06 | 6.68 | 11.19 |
| E′ (100° C.) | 4.15 | 4.28 | 5.65 | 7.36 |
| E′ (120° C.) | 4.08 | 4.20 | 5.58 | 5.79 |
| Tandelta (23° C.) | 0.480 | 0.527 | 0.456 | 0.486 |
| Tandelta (70° C.) | 0.305 | 0.318 | 0.297 | 0.343 |
| Tandelta (100° C.) | 0.239 | 0.244 | 0.229 | 0.308 |
| Tandelta (120° C.) | 0.210 | 0.212 | 0.202 | 0.302 |
| Tandelta | 0.78 | 0.77 | 0.77 | 0.90 |
| (100° C.)/Tandelta | | | | |
| (70° C.) | | | | |
| Tandelta | 0.69 | 0.67 | 0.68 | 0.88 |
| (120° C.)/Tandelta | | | | |
| (70° C.) | | | | |
| Tandelta | 0.88 | 0.87 | 0.88 | 0.98 |
| (120° C.)/Tandelta | | | | |
| (100° C.) | | | | |
| IRHD hardness at | 72 | 76 | 84 | 90 |
| 23° C. | | | | |
| IRHD hardness at | 54 | 56 | 62 | 63 |
| 100° C. | | | | |
| DIN abrasion | 100 | 92 | 94 | 103 |
| (index) | | | | |

(*): comparative.

The results given in Table 2 show that the crosslinked manufactured product comprising the cycloolefin polymer according to the present invention (Example 5) has improved hysteresis properties at high temperatures. In particular, althoug the Tandelta valpe decreases as the temperature increases, it decreases less than that of the comparative compositions. The elastomeric compositions according to the invention thus allow to obtain a better roadholding at high temperatures. In addition, these effects were obtained without any remarkable worsening of abrasion resistance.

1-42. (canceled)

43. A tyre for a vehicle wheel, comprising:
at least one component made of a crosslinked elastomeric material;
wherein the at least one component comprises an elastomeric composition, comprising:
at least one diene elastomeric polymer; and
at least one cycloolefin polymer;
wherein the at least one cycloolefin polymer comprises a glass transition temperature greater than or equal to 50° C.

44. The tyre of claim 43, comprising:
a carcass structure;
a belt structure applied in a circumferentially external position relative to the carcass structure;
a tread band superpositioned circumferentially relative to the belt structure; and
a pair of sidewalls applied laterally on opposite sides relative to the carcass structure;
wherein the carcass structure comprises at least one carcass ply,
wherein the at least one carcass ply is shaped in a substantially toroidal configuration,
wherein opposite lateral edges of the carcass structure are associated with respective bead wires,
wherein each bead wire is enclosed in a respective bead,
wherein the belt structure comprises at least one belt strip, and
wherein the at least one component comprising the elastomeric composition is the tread band.

45. The tyre of claim 43, wherein the at least one cycloolefin polymer comprises a glass transition temperature greater than or equal to 60° C. and less than or equal to 250° C.

46. The tyre of claim 43, wherein the at least one cycloolefin polymer comprises a glass transition temperature greater than or equal to 80° C. and less than or equal to 200° C.

47. The tyre of claim 43, wherein the at least one cycloolefin polymer comprises a glass transition temperature greater than or equal to 100° C. and less than or equal to 160° C.

48. The tyre of claim 43, wherein the at least one cycloolefin polymer is selected from:
a cycloolefin random copolymer obtained by copolymerizing:
at least one aliphatic α-olefin;
at least one cycloolefin represented by the following formula (I); and
optionally, a polyene;
a ring-opening polymer of at least one cycloolefin represented by the following formula (I); and
a hydrogenation product of a ring-opening polymer of at least one cycloolefin represented by the following formula (I): 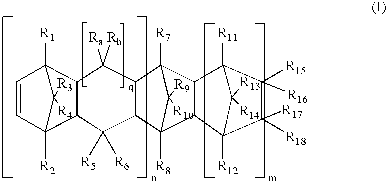
wherein:
n is 0 or a positive integer;
m is 0 or a positive integer;
q is 0 or 1;
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, Rₐ, and R_{b}, which may be the same as or different from each other, represent a hydrogen atom, a halogen atom, an aliphatic hydrocarbon group, an alicyclic hydrocarbon group, or an aromatic hydrocarbon group;
R₁₅, R₁₆, R₁₇, and R₁₈, may be linked to each other to form a monocyclic or polycyclic group that may have double bonds; and
R₁₅ and R₁₆ or R₁₇ and R₁₈ may together form an alkylidene group.

49. The tyre of claim 48, wherein the at least one aliphatic α-olefin is an olefin of formula CH₂═CH—R, and
wherein R represents a hydrogen atom, a linear alkyl group containing from 1 to 12 carbon atoms, or a branched alkyl group containing from 1 to 12 carbon atoms.

50. The tyre of claim 48, wherein the at least one aliphatic α-olefin comprises one or more of: ethylene; propylene; 1-butene; isobutylene; 1-pentene; 1-hexene; 3-methyl-1-butene; 3-methyl-1-pentene; 4-methyl-1-pentene; 4-methyl-1-hexene; 4,4-dimethyl-1-hexene; 4,4-dimethyl-1-pentene; 4-ethyl-1-hexene; 3-ethyl-1-hexene; l-octene; 1-decene; 1-dodecene; 1-tetradecene; 1-hexadecene; 1-octadecene; and 1-eicosene.

51. The tyre of claim 48, wherein the at least one aliphatic α-olefin comprises ethylene, propylene, or ethylene and propylene.

52. The tyre of claim 43, wherein the at least one cycloolefin polymer comprises one or more copolymers of a cyclic olefin comprising a norbornene structure and an aliphatic α-olefin.

53. The tyre of claim 43, wherein the at least one cycloolefin polymer comprises one or more of: norbornene-ethylene copolymers; norbornene-propylene copolymers; tetracyclododecene-ethylene copolymers; and tetracyclododecene-propylene copolymers.

54. The tyre of claim 43, wherein the at least one cycloolefin polymer comprises a norbornene-ethylene copolymer.

55. The tyre of claim 48, wherein the polyene is a diene.

56. The tyre of claim 43, wherein the elastomeric composition comprises an amount of the at least one cycloolefin polymer greater than or equal to 0.1 phr and less than or equal to 100 phr.

57. The tyre of claim 43, wherein the elastomeric composition comprises an amount of the at least one cycloolefin polymer greater than or equal to 3 phr and less than or equal to 60 phr.

58. The tyre of claim 43, wherein the elastomeric composition comprises an amount of the at least one cycloolefin polymer greater than or equal to 5 phr and less than or equal to 40 phr.

59. The tyre of claim 43, wherein the at least one diene elastomeric polymer comprises a glass transition temperature less than 20° C.

60. The tyre of claim 43, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

61. The tyre of claim 43, wherein the elastomeric composition further comprises at least one elastomeric polymer of one or more monoolefins with an olefinic comonomer or derivatives thereof.

62. The tyre of claim 61, wherein the at least one elastomeric polymer comprises one or more of: ethylene/propylene copolymers (EPR); ethylene/propylene/diene copolymers (EPDM); polyisobutene; butyl rubbers; and halobutyl rubbers.

63. The tyre of claim 43, wherein the elastomeric composition comprises at least one reinforcing filler in an amount greater than or equal to 0.1 phr and less than or equal to 120 phr.

64. The tyre of claim 63, wherein the at least one reinforcing filler comprises carbon black.

65. The tyre of claim 63, wherein the at least one reinforcing filler comprises silica.

66. A tread band for a tyre, comprising:
a crosslinkable elastomeric composition;
wherein the crosslinkable elastomeric composition comprises:
at least one diene elastomeric polymer; and
at least one cycloolefin polymer;
wherein the at least one cycloolefin polymer comprises a glass transition temperature greater than or equal to 50° C.

67. The tread band of claim 66, wherein the at least one cycloolefin polymer comprises a glass transition temperature greater than or equal to 80° C. and less than or equal to 200° C.

68. The tread band of claim 66, wherein the at least one cycloolefin polymer comprises a glass transition temperature greater than or equal to 100° C. and less than or equal to 160° C.

69. The tread band of claim 66, wherein the at least one cycloolefin polymer is selected from:
a cycloolefin random copolymer obtained by copolymerizing:
at least one aliphatic α-olefin;
at least one cycloolefin represented by the following formula (I); and
optionally, a polyene;
a ring-opening polymer of at least one cycloolefin represented by the following formula (I); and
a hydrogenation product of a ring-opening polymer of at least one cycloolefin represented by the following formula (I): 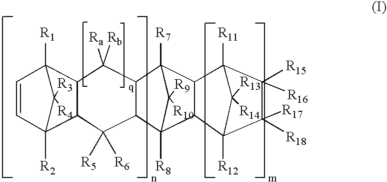
wherein:
n is 0 or a positive integer;
m is 0 or a positive integer;
q is 0 or 1;
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, Rₐ, and R_{b}, which may be the same as or different from each other, represent a hydrogen atom, a halogen atom, an aliphatic hydrocarbon group, an alicyclic hydrocarbon group, or an aromatic hydrocarbon group;
R₁₅, R₁₆, R₁₇, and R₁₈, may be linked to each other to form a monocyclic or polycyclic group that may have double bonds; and
R₁₅ and R₁₆ or R₁₇ and R₁₈ may together form an alkylidene group.

70. The tread band of claim 66, wherein the at least one diene elastomeric polymer comprises a glass transition temperature less than 20° C.

71. The tread band of claim 66, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

72. The tread band of claim 66, wherein the elastomeric composition further comprises at least one elastomeric polymer of one or more monoolefins with an olefinic comonomer or derivatives thereof.

73. The tread band of claim 72, wherein the at least one elastomeric polymer comprises one or more of: ethylene/propylene copolymers (EPR); ethylene/propylene/diene copolymers (EPDM); polyisobutene; butyl rubbers; and halobutyl rubbers.

74. The tread band of claim 66, wherein the elastomeric composition comprises at least one reinforcing filler in an amount greater than or equal to 0.1 phr and less than or equal to 120 phr.

75. The tread band of claim 74, wherein the at least one reinforcing filler comprises carbon black.

76. The tread band of claim 74, wherein the at least one reinforcing filler comprises silica.

77. An elastomeric composition, comprising:
at least one diene elastomeric polymer; and
at least one cycloolefin polymer;
wherein the at least one cycloolefin polymer comprises a glass transition temperature greater than or equal to 50° C.

78. The composition of claim 77, wherein the at least one cycloolefin polymer comprises a glass transition temperature greater than or equal to 80° C. and less than or equal to 200° C.

79. The composition of claim 77, wherein the at least one cycloolefin polymer comprises a glass transition temperature greater than or equal to 100° C. and less than or equal to 160° C.

80. The composition of claim 77, wherein the at least one cycloolefin polymer is selected from:
a cycloolefin random copolymer obtained by copolymerizing:
at least one aliphatic α-olefin;
at least one cycloolefin represented by the following formula (I); and
optionally, a polyene;
a ring-opening polymer of at least one cycloolefin represented by the following formula (I); and
a hydrogenation product of a ring-opening polymer of at least one cycloolefin represented by the following formula (I): 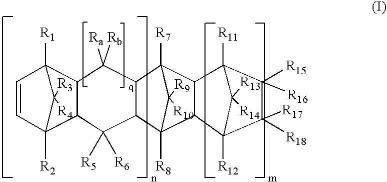
wherein:
n is 0 or a positive integer;
m is 0 or a positive integer;
q is 0 or 1;
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, Rₐ, and R_{b}, which may be the same as or different from each other, represent a hydrogen atom, a halogen atom, an aliphatic hydrocarbon group, an alicyclic hydrocarbon group, or an aromatic hydrocarbon group;
R₁₅, R₁₆, R₁₇, and R₁₈, may be linked to each other to form a monocyclic or polycyclic group that may have double bonds; and
R₁₅ and R₁₆ or R₁₇ and R₁₈ may together form an alkylidene group.

81. The composition of claim 77, wherein the at least one diene elastomeric polymer comprises a glass transition temperature less than 20° C.

82. The composition of claim 77, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

83. The composition of claim 77, wherein the elastomeric composition further comprises at least one elastomeric polymer of one or more monoolefins with an olefinic comonomer or derivatives thereof.

84. The composition of claim 83, wherein the at least one elastomeric polymer comprises one or more of: ethylene/propylene copolymers (EPR); ethylene/propylene/diene copolymers (EPDM); polyisobutene; butyl rubbers; and halobutyl rubbers.

85. The composition of claim 77, further comprising at least one reinforcing filler in an amount greater than or equal to 0.1 phr and less than or equal to 120 phr.

86. The composition of claim 77, wherein the at least one reinforcing filler comprises carbon black.

87. The composition of claim 77, wherein the at least one reinforcing filler comprises silica.

88. A crosslinked elastomeric manufactured product obtained by crosslinking an elastomeric composition,
wherein the elastomeric composition comprises:
at least one diene elastomeric polymer; and
at least one cycloolefin polymer;
wherein the at least one cycloolefin polymer comprises a glass transition temperature greater than or equal to 50° C.
